(19) United States
(12) Patent Application Publication
(10) Pub. No.: US 2022/0366697 A1
(43) Pub. Date: Nov. 17, 2022

(54) IMAGE PROCESSING METHOD AND APPARATUS, ELECTRONIC DEVICE AND STORAGE MEDIUM

(71) Applicant: SHENZHEN SENSETIME TECHNOLOGY CO., LTD., Shenzhen (CN)

(72) Inventors: Xiaoying HUANG, Shenzhen (CN); Weilin LI, Shenzhen (CN); An CAO, Shenzhen (CN)

(21) Appl. No.: 17/874,477

(22) Filed: Jul. 27, 2022

Related U.S. Application Data
(63) Continuation of application No. PCT/CN2021/090305, filed on Apr. 27, 2021.

(30) Foreign Application Priority Data
Sep. 28, 2020 (CN) 202011043572.X

(51) Int. Cl. G06V 20/52; G06V 10/62; G06V 10/75; G06V 20/40; G06T 7/60; G08B 21/18

(52) U.S. Cl. CPC G06V 20/52; G06V 10/62; G06V 10/751; G06V 20/44; G06T 7/60; G08B 21/18; G06V 2201/08; G06V 40/10

(57) ABSTRACT

An image processing method and apparatus, an electronic device and a storage medium are provided. The method includes: at least one image to be processed and at least one attribute filtering condition of an event to be monitored are obtained; event detection is performed on the at least one image to be processed to obtain an intermediate detection result of the event to be monitored; event attribute extraction is performed on the at least one image to be processed to obtain at least one attribute of the event to be monitored; and a target monitoring result of the event to be monitored is obtained according to the intermediate detection result, the at least one attribute and the at least one attribute filtering condition of the event to be monitored.

### CROSS-REFERENCE TO RELATED APPLICATIONS

This is a continuation application of International Patent Application No. PCT/CN2021/090305, filed on Apr. 27, 2021, which claims priority to Chinese Patent Application No. 202011043572.X, filed on Sep. 28, 2020 and entitled “Image Processing Method and Apparatus, Electronic Device and Storage Medium”. The disclosures of International Patent Application No. PCT/CN2021/090305 and Chinese Patent Application No. 202011043572.X are hereby incorporated by reference in its entirety.

### BACKGROUND

With the rapid development of computer vision technology, various computer vision models with different functions emerge at the right moment. An electronic device uses the computer vision model to process an image to determine whether there are violations in the image. The violations include garbage overflow, fights and the like. However, the accuracy of the computer vision model in determining the violations is low.

### SUMMARY

The disclosure provides an image processing method and apparatus, an electronic device and a storage medium.

A first aspect provides an image processing method, which may include the following operations.

At least one image to be processed and at least one attribute filtering condition of an event to be monitored are obtained.

Event detection is performed on the at least one image to be processed to obtain an intermediate detection result of the event to be monitored.

Event attribute extraction is performed on the at least one image to be processed to obtain at least one attribute of the event to be monitored.

A target monitoring result of the event to be monitored is obtained according to the intermediate detection result, the at least one attribute and the at least one attribute filtering condition of the event to be monitored.

A second aspect provides an image processing apparatus, which may include an obtaining unit, an event detecting unit, an attribute extracting unit, and a processing unit.

The obtaining unit is configured to obtain at least one image to be processed and at least one attribute filtering condition of the event to be monitored.

The event detecting unit is configured to perform event detection on the at least one image to be processed to obtain an intermediate detection result of the event to be monitored.

The attribute extracting unit is configured to perform event attribute extraction on the at least one image to be processed to obtain at least one attribute of the event to be monitored.

The processing unit is configured to obtain a target monitoring result of the event to be monitored according to the intermediate detection result, the at least one attribute and the at least one attribute filtering condition of the event to be monitored.

A third aspect provides a processor, which may be configured to execute the method in the first aspect and any possible implementation mode thereof.

A fourth aspect provides an electronic device, which may include a processor, a sending apparatus, an input apparatus, an output apparatus, and a memory. The memory may be configured to store a computer program code. The computer program code may include a computer instruction. When the processor executes the computer instruction, the electronic device may execute the method in the first aspect and any possible implementation mode thereof.

A fifth aspect provides a computer-readable storage medium, which stores a computer program. The computer program may include a program instruction, and the program instruction may be executed by a processor to enable the processor to execute the method in the first aspect and any possible implementation mode thereof.

A sixth aspect provides a computer program product, which includes a computer program or instruction. The computer program or instruction may run in a computer to enable the computer to execute the method in the first aspect and any possible implementation mode thereof.

It is to be understood that the above general descriptions and detailed descriptions below are only exemplary and explanatory and not intended to limit the disclosure.

### BRIEF DESCRIPTION OF THE DRAWINGS

In order to describe the technical solutions in the embodiments of the disclosure or the background art more clearly, the drawings required for descriptions about the embodiments of the disclosure or the background art will be described below.

The accompanying drawings, which are incorporated in and constitute a part of this specification, illustrate embodiments consistent with the disclosure and, together with the specification, serve to illustrate the technical solutions of the disclosure.

FIG. 1 is a schematic flowchart of an image processing method provided by an embodiment of the disclosure.

FIG. 2 is a schematic structural diagram of an image processing apparatus provided by an embodiment of the disclosure.

FIG. 3 is a hardware structure diagram of an image processing apparatus provided by an embodiment of the disclosure.

### DETAILED DESCRIPTION

In order to make those skilled in the art understand the solutions of the disclosure better, the technical solutions in the embodiments of the disclosure are clearly and completely elaborated below in combination with the accompanying drawings. It is apparent that the described embodiments are only a part of the embodiments of the disclosure but not all. All other embodiments obtained by those of ordinary skill in the art based on the embodiments in the disclosure without creative work shall fall within the scope of protection of the disclosure.

The specification and claims of the disclosure and terms “first”, “second”, etc.

in the accompanying drawings are used for distinguishing different objects rather than describing a specific sequence. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

In the disclosure, the term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B or C may represent including any one or more elements selected from a set formed by A, B and C.

“Embodiment” mentioned herein means that a specific feature, structure or characteristic described in combination with an embodiment may be included in at least one embodiment of the disclosure. Each position where this phrase appears in the specification does not always refer to the same embodiment as well as an independent or alternative embodiment mutually exclusive to another embodiment. It is explicitly and implicitly understood by those skilled in the art that the embodiments described in the disclosure may be combined with other embodiments.

With the rapid development of computer vision technology, various computer vision models with different functions emerge at the right moment. For example, a face recognition model may be used to recognize a human face, an object detection model may be used to detect an object, an action monitoring model may be used to monitor whether a specific action occurs.

Based on this, an electronic device may process an image using a computer vision model to determine whether there are violations in the image. The violations include garbage overflow, fights, etc.

It is necessary to train a computer vision model before an image is processed by using the computer vision model. The training effect of the computer vision model may directly affect the accuracy of the computer vision model in determining the violations.

In the process of training the computer vision model, over-fitting and under-fitting are easy to occur. When the two cases occur, the accuracy of the trained computer vision model in determining the violations is low. Based on this, the embodiments of the disclosure provide a technical solution to correct a determination result of the computer vision model for the violations, thereby improving the accuracy in determining the violations.

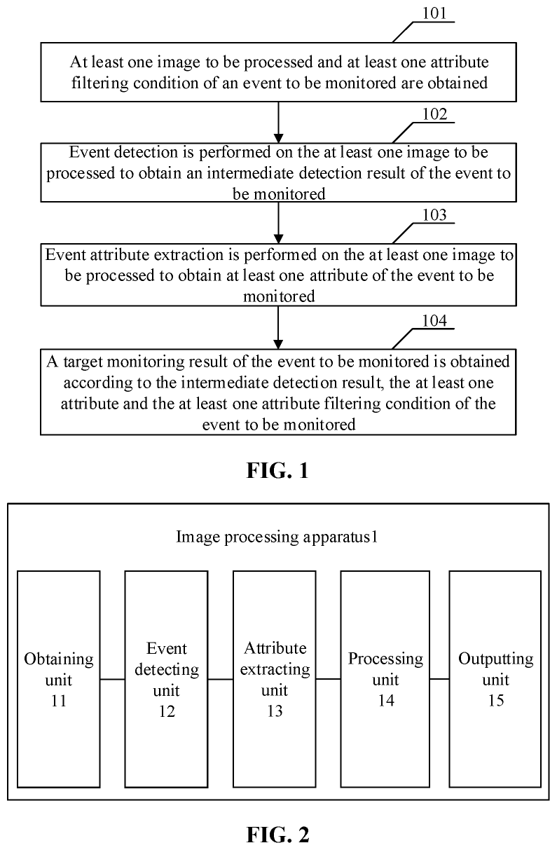

The image processing method provided by the embodiments of the disclosure is performed by an image processing apparatus. Optionally, the image processing apparatus may be one of the following: a mobile phone, a computer, a server, a processor, and a tablet PC. In some possible implementation modes, the image processing method may be implemented by means of a processor calling a computer-readable instruction stored in the memory. The embodiments of the disclosure are described below in combination with the accompanying drawings in the embodiments of the disclosure. FIG. 1 is a schematic flowchart of an image processing method provided by an embodiment of the disclosure.

In 101, at least one image to be processed and at least one attribute filtering condition of an event to be monitored are obtained.

In the embodiments of the disclosure, the image to be processed may include any content. For example, the image to be processed may include roads. For another example, the image to be processed may include roads and vehicles. For another example, the image to be processed may include people. The disclosure does not limit the content in the image to be processed.

In an implementation mode of obtaining at least one image to be processed, the image processing apparatus receives at least one image to be processed input by a user through an input component. The input component includes a keyboard, a mouse, a touch screen, a touch pad, an audio input unit, etc.

In another implementation mode of obtaining at least one image to be processed, the image processing apparatus receives at least one image to be processed sent by a first terminal. Optionally, the first terminal may be any one of a mobile phone, a computer, a tablet computer, a server, or a wearable device.

In another implementation mode of obtaining at least one image to be processed, there is a communication connection between the image processing apparatus and a surveillance camera. The image processing apparatus may receive at least one image to be processed sent by the surveillance camera through the communication connection. Optionally, the surveillance camera is deployed on roads or indoors.

In another implementation mode of obtaining at least one image to be processed, there is a communication connection between the image processing apparatus and the surveillance camera. The image processing apparatus may receive a video stream sent by the surveillance camera through the communication connection, and takes at least one image in the video stream as the at least one image to be processed. Optionally, the surveillance camera is deployed on roads or indoors.

In another implementation mode of obtaining at least one image to be processed, the image processing apparatus may directly acquire at least one image to be processed through its own image acquisition component, such as a camera.

In the embodiments of the disclosure, the event to be monitored may be any event. Optionally, the event to be monitored is a violation. The event to be monitored includes at least one of the following: fights, people gathering, garbage overflow, or illegal parking.

In the embodiments of the disclosure, the attribute filtering condition of the event to be monitored is used for filtering out misidentified events. The attribute filtering conditions of the event to be monitored include: the minimum number of people fighting, the minimum number of people gathering, the monitoring time of garbage overflow, the location of illegal parking area, and the confidence of detection object.

For example, at least two people are required to participate in a fight. If the event to be monitored is a fight, the attribute filtering condition of the event to be monitored may be at least two people. In this way, if the image processing apparatus uses the computer vision model to process a certain image, the obtained processing result is that the image includes a fighting event, and the image processing apparatus may use the attribute filtering condition to filter out the fighting event.

For another example, at least two people are required to participate in people gathering. If the event to be monitored is people gathering, the attribute filtering condition of the event to be monitored may be at least two people. In this way, if the image processing apparatus uses the computer vision model to process a certain image, the obtained processing result is that the image includes a people gathering event, and the image processing apparatus may use the attribute filtering condition to filter out the people gathering event.

For another example, the working time of the staff for handling garbage overflow is from 9:00 to 20:00. If the event to be monitored is garbage overflow, the attribute filtering condition of the event to be monitored may be from 9:00 to 20:00. In this way, if the image processing apparatus uses the computer vision model to process a certain image, the obtained processing result is that the image includes a garbage overflow event. The image processing apparatus may filter out the garbage overflow event included in the image when determining that the time of acquiring the image is between 20:00 and 9:00.

For another example, a vehicle is parked illegally when the vehicle is parked in an illegal parking area, while the vehicle is not parked illegally when the vehicle is not parked in the illegal parking area. Therefore, if the event to be monitored is illegal parking, the attribute filtering condition of the event to be monitored may be the location of the illegal parking area. In this way, if the image processing apparatus uses the computer vision model to process a certain image, the obtained processing result is that the vehicle A in the image is parked illegally, and when the image processing apparatus determines that the location of the vehicle A is outside the illegal parking area, the image processing apparatus may determine that the image does not include the illegal parking event.

For another example, if the event to be monitored is illegal intrusion of a pedestrian, when the computer vision model detects illegal intrusion of an object to be identified in the image to be processed, the image processing apparatus performs object detection on the image to be processed to obtain the confidence of the object to be identified. When the confidence does not exceed a confidence threshold, the image processing apparatus determines that the object to be identified is not a person, so it may be determined that the image to be processed does not include an event of illegal intrusion of pedestrian.

In 102, event detection is performed on the at least one image to be processed to obtain an intermediate detection result of the event to be monitored.

In the embodiments of the disclosure, event detection may be implemented by a computer vision model. The computer vision models include: a fight detection model, a people gathering detection model, a garbage overflow detection model, and an illegal parking detection model.

In the embodiments of the disclosure, the intermediate detection result of the event to be monitored includes: the event to be monitored exists in at least one image to be processed, or the event to be monitored does not exist in the at least one image to be processed. The image processing apparatus may obtain the intermediate detection result by using the computer vision model to perform event detection on the at least one image to be processed.

For example, assuming that the computer vision model is the fight detection model, the image processing apparatus may determine whether the image includes the fighting event by using the fight detection model to perform event detection on the image.

For example, assuming that the computer vision model is the people gathering detection model, the image processing apparatus may determine whether the image includes the people gathering event by using the people gathering detection model to perform event detection on the image.

For another example, assuming that the computer vision model is the garbage overflow detection model, the image processing apparatus may determine whether the image includes the garbage overflow event by using the garbage overflow detection model to perform event detection on the image.

For another example, assuming that the computer vision model is the illegal parking detection model, the image processing apparatus may determine whether the image includes the illegal parking event by using the illegal parking detection model to perform event detection on the image.

In 103, event attribute extraction is performed on the at least one image to be processed to obtain at least one attribute of the event to be monitored.

In the embodiments of the disclosure, the attributes of the event to be monitored include: the number of people, the occurrence time, a vehicle location, and the duration in which a vehicle stays. For example, when the event to be monitored is the fighting event, at least one attribute of the event to be monitored includes the number of people in the image and a distance between people; when the event to be monitored is the people gathering event, at least one attribute of the event to be monitored includes the number of people in the image; when the event to be monitored is the garbage overflow event, at least one attribute of the event to be monitored includes the time of acquiring the image, that is, the occurrence time of garbage overflow; and when the event to be monitored is the illegal parking event, at least one attribute of the event to be monitored includes a vehicle location in the image and the duration in which the vehicle stays.

In an implementation mode of performing event attribute extraction on at least one image to be processed, at least one attribute of the event to be monitored may be obtained by inputting at least one image to be processed into an attribute extraction model. The attribute extraction model may be a convolutional neural network trained by taking the image with attributes as annotation information as training data. Event attribute extraction is performed on the at least one image to be processed through the attribute extraction model to obtain at least one attribute of the event to be monitored.

For example, at least one image to be processed includes image 1 to be processed. The attributes of the event to be monitored obtained by performing event attribute extraction on the image 1 to be processed through the attribute extraction model include: the number of people included in the image 1 to be processed.

For another example, at least one image to be processed includes image 1 to be processed and image 2 to be processed. The attributes of the event to be monitored obtained by performing event attribute extraction on the image 1 to be processed and the image 2 to be processed through the attribute extraction model include: the location of the vehicle in the image 1 to be processed, the location of the vehicle in the image 2 to be processed, and the duration of the vehicle staying in the image 1 to be processed and the image 2 to be processed.

For another example, at least one image to be processed includes image 1 to be processed and image 2 to be processed. The attributes of the event to be monitored obtained by performing event attribute extraction on the image 1 to be processed and the image 2 to be processed through the attribute extraction model include: the number of people included in the image 1 to be processed, the location of the vehicle in the image 1 to be processed, the location of the vehicle in the image 2 to be processed, and the duration of the vehicle staying in the image 1 to be processed and the image 2 to be processed.

In 104, a target monitoring result of the event to be monitored is obtained according to the intermediate detection result, the at least one attribute and the at least one attribute filtering condition of the event to be monitored.

If the intermediate detection result of the event to be monitored is that there is no event to be monitored in at least one image to be processed, the target monitoring result is that the event to be monitored does not occur. If the intermediate detection result of the event to be monitored is that the event to be monitored exists in at least one image to be processed, and the attribute of the event to be monitored does not meet the attribute filtering condition, it is indicated that the event to be monitored does not occur, that is, a detection result of the computer vision model is wrong, and in such case, the target monitoring result is that the event to be monitored does not occur. If the intermediate detection result of the event to be monitored is that there is the event to be monitored in at least one image to be processed, and the attribute of the event to be monitored meets the attribute filtering condition, it is indicated that the event to be monitored has occurred, that is, the detection result of the computer vision model is correct, and in such case, the target monitoring result is that the event to be monitored has occurred.

As an optional implementation mode, when the intermediate detection result is that there is the event to be monitored in at least one image to be processed, and at least one attribute meets at least one attribute filtering condition, the image processing apparatus determines the target monitoring result to be that the event to be monitored has occurred; and when the intermediate detection result is that there is the event to be monitored in at least one image to be processed, and at least one attribute does not meet at least one attribute filtering condition, the image processing apparatus determines the target monitoring result to be that the event to be monitored does not occur.

For example, assuming that the event to be monitored is the fighting event, and the intermediate detection result is that the image 1 to be processed includes the fighting event, at least one attribute of the event to be monitored includes that: the image 1 to be processed includes two people and the distance between the two people is 3 meters, and the attribute filtering condition is that at least two people are included and the distance between any two people is less than 1 meter. Because the distance between the two people in the image 1 to be processed exceeds 1 meter, that is, the attribute of the event to be monitored does not meet the attribute filtering condition, the image processing apparatus determines the target monitoring result to be that no fighting event occurs in the image 1 to be processed.

In the embodiments of the disclosure, by filtering the intermediate detection result according to the attribute and attribute filtering condition of the event to be monitored, the image processing apparatus may filter out the detection result that the attribute does not meet the attribute filtering condition, and obtain the target monitoring result, thereby improving the accuracy of the target monitoring result.

As an optional implementation mode, the image processing apparatus performs the following operations during the operation in 103.

In 1, when the intermediate detection result is that the event to be monitored exists in the at least one image to be processed, event attribute extraction is performed on the at least one image to be processed to obtain at least one attribute of the event to be monitored.

In this operation, the image processing apparatus first performs the operation in 102 to obtain the intermediate detection result. When it is determined that the intermediate detection result is that the event to be monitored exists in at least one image to be processed, the operation in 103 is performed, which may reduce the amount of data processing of the image processing apparatus.

As an optional implementation mode, the image processing apparatus performs the following operation during the operation in 102.

In 2, when the at least one attribute meets the attribute filtering condition, event detection is performed on the at least one image to be processed to obtain the intermediate detection result of the event to be monitored.

In this operation, the image processing apparatus first performs the operation in 103 to obtain at least one attribute of the event to be monitored. When it is determined that at least one attribute of the event to be monitored meets the attribute filtering condition, the operation in 102 is performed, which may reduce the amount of data processing of the image processing apparatus.

For example, assuming that the event to be monitored is the fighting event, the image processing apparatus performs event attribute extraction on the image 1 to be processed to determine that the image 1 to be processed includes only one person. It is apparent that there is no fighting event in the image 1, so the image processing apparatus may no longer perform the operation in 102.

As an optional implementation mode, the event to be monitored includes illegal intrusion, at least one image to be processed includes a first image, and the first image includes the illegal intrusion area. The image processing apparatus performs the following operation during the operation in 102.

In 3, when it is determined that a monitored object exists in the illegal intrusion area, the intermediate detection result is determined to be that the illegal intrusion exists in the first image.

In the embodiments of the disclosure, the illegal intrusions include at least one of an illegal intrusion of non-motor vehicle or an illegal intrusion of pedestrian. The monitored objects include at least one of the following: a person and a non-motor vehicle. The illegal intrusion areas include a highway area, a motor vehicle driving area, and a specific area.

For example, the illegal intrusion of pedestrian means that it is easy to cause safety accidents when pedestrians enter the highway area. Therefore, when the event to be monitored is the illegal intrusion of pedestrian, the illegal intrusion area includes the highway area.

For another example, the illegal intrusion of non-motor vehicle means that it is easy to cause safety accidents when non-motor vehicles enter the motor vehicle driving area. Therefore, when the event to be monitored is the illegal intrusion of non-motor vehicle, the illegal intrusion area includes the motor vehicle driving area.

For another example, a meeting is being held in meeting room A, participants of the meeting are all invited by the organizer, and the meeting does not allow people other than the participants to enter the meeting room A. Therefore, when the event to be monitored is the illegal intrusion of visitor, the illegal intrusion area includes the meeting room A. That is, the meeting room A is the specific area.

If the image processing apparatus performs event detection on the first image to determine that there is the monitored object in the illegal intrusion area, it is indicated that the monitored object has intruded illegally. If the image processing apparatus performs event detection on the first image to determine that there is no monitored object in the illegal intrusion area, it is indicated that the monitored object does not intrude illegally.

Therefore, when it is determined that there is the monitored object in the illegal intrusion area, the image processing apparatus determines the intermediate detection result to be that there is an illegal intrusion in the first image, and when it is determined that there is no monitored object in the illegal intrusion area, the image processing apparatus determines the intermediate detection result to be that there is no illegal intrusion in the first image.

For example, the first image is acquired by the surveillance camera on the road. Because a monitoring area of the surveillance camera on the road is fixed, an area corresponding to an illegal intrusion area of non-motor vehicle on the road may be determined as the illegal intrusion area in the monitoring area of the surveillance camera. For example, when the surveillance camera is deployed on a highway, the highway area within the monitoring area may be taken as the illegal intrusion area. In this way, the image processing apparatus may determine whether there is a non-motor vehicle in the illegal intrusion of non-motor vehicle by performing event detection on the first image, and then obtain a detection result.

As an optional implementation mode, at least one image to be processed includes a second image, at least one attribute filtering condition includes a white list feature database, and at least one attribute includes identity features of the monitored object. The image processing apparatus performs the following operation during the operation in 103.

In 4, identity feature extraction is performed on the second image to obtain identity feature data of the monitored object.

This operation is applied to the illegal intrusion in the specific area. The white list feature database includes face feature data and/or human body feature data of the people in a white list. The white list is a list of people allowed to enter the specific area. For example, if the specific area is a meeting place, the white list includes meeting participants; if the specific area is an office area of a company, the white list includes employees of the company.

In the embodiments of the disclosure, the identity feature data includes at least one of the face feature data or the human body feature data. The human body feature data carries identity information of a person in the image.

The identity information carried in the human body feature data includes: clothing attributes, appearance features and change features of the person. The clothing attributes include at least one of the characteristics of all the objects that decorate the human body (such as coat color, pants color, pants length, hat style, shoe color, holding up an umbrella or not, bag type, wearing a mask or not, and mask color). The appearance features include body type, gender, hairstyle, hair color, age, wearing glasses or not, and holding something on the chest or not. The change features include posture and stride.

For example, the categories of coat color or pants color or shoe color or hair color include: black, white, red, orange, yellow, green, blue, purple, and brown. The categories of pants length include: trouser, short and skirt. The categories of hat styles include: no hat, baseball cap, cap, flat brim, bucket hat, beret and top hat. The categories of holding up an umbrella or not include: holding up an umbrella and not holding up an umbrella. The categories of hairstyle include: shoulder-length hair, short hair, shaved head and bald head. The categories of posture include: cycling posture, standing posture, walking posture, running posture, sleeping posture and lying posture. The stride refers to the size of a person's stride when walking. The stride size may be expressed by lengths, such as 0.3 m, 0.4 m, 0.5 m and 0.6 m.

In this implementation mode, the image processing apparatus determines whether there is feature data matching with the identity feature data in the white list feature database by comparing the identity feature data with feature data in the white list feature database, so as to determine whether at least one attribute meets at least one attribute filtering condition.

Specifically, when the image processing apparatus determines that there is no feature data matching with the identity feature data in the white list feature database, it is indicated that the monitored object does not belong to the white list; in this case, the image processing apparatus may determine that at least one attribute meets at least one attribute filtering condition. When the image processing apparatus determines that there is feature data matching with the identity feature data in the white list feature database, it is indicated that the monitored object belongs to the white list; in this case, the image processing apparatus may determine that at least one attribute does not meet at least one attribute filtering condition.

The image processing apparatus may reduce misjudgment and improve the accuracy of the target monitoring result by taking the white list feature database as the attribute filtering condition.

As an optional implementation mode, the at least one attribute filtering condition also includes a size range, and the at least one attribute also includes the size of the monitored object. The image processing apparatus also performs the following operation during the operation in 103.

In 5, object detection is performed on the second image to obtain the size of the monitored object.

In the embodiments of the disclosure, a size of an object to be monitored is the size of the object to be monitored in the image. For example, assuming that the object to be monitored is a person, the size of the object to be monitored may be the length of a pixel area covered by the person in the image. For another example, assuming that the object to be monitored is a vehicle, the size of the object to be monitored may be the width of a pixel area covered by the vehicle in the image.

In some scenarios, the location of the camera that acquires the image to be processed is fixed, so the size of the monitored object in the image acquired by the camera is in a fixed range. In the embodiments of the disclosure, the fixed range is called a size range.

For example, in the image acquired by the surveillance camera at an intersection, the minimum height of a person is 5 pixels and the maximum height is 15 pixels, in this case, a height range is [5, 15]. For another example, in the image acquired by the surveillance camera at an intersection, the minimum width of a vehicle is 10 pixels and the maximum width is 20 pixels, in this case, a size range is [10, 20].

The image processing apparatus may obtain the size of the monitored object in the second image by performing object detection on the second image. For example, when the monitored object is a person, the image processing apparatus may obtain a person box including the person by performing person detection on the second image, and then obtain the size of the person in the second image according to the size of the person box. For another example, when the monitored object is a vehicle, the image processing apparatus may obtain a vehicle box including the vehicle by performing vehicle detection on the second image, and then obtain the size of the vehicle in the second image according to the size of the vehicle box.

In this implementation mode, the image processing apparatus determines whether there is feature data matching with the identity feature data in the white list feature database by comparing the identity feature data with the feature data in the white list feature database, and determines whether the size of the monitored object is within the size range, so as to determine whether at least one attribute meets at least one attribute filtering condition.

Specifically, when the image processing apparatus determines that there is no feature data matching with the identity feature data in the white list feature database and the size of the monitored object is within the size range, it is indicated that the monitored object does not belong to the white list. In this case, the image processing apparatus may determine that the at least one attribute meets at least one attribute filtering condition.

When the image processing apparatus determines that there is feature data matching with the identity feature data in the white list feature database and the size of the monitored object is within the size range, it is indicated that the monitored object belongs to the white list. In this case, the image processing apparatus may determine that the at least one attribute does not meet at least one attribute filtering condition.

When the image processing apparatus determines that there is no feature data matching with the identity feature data in the white list feature database and the size of the monitored object is outside the size range, it is indicated that the monitored object does not belong to the white list. In this case, the image processing apparatus may determine that the at least one attribute does not meet at least one attribute filtering condition.

When the image processing apparatus determines that there is feature data matching with the identity feature data in the white list feature database and the size of the monitored object is outside the size range, it is indicated that the monitored object belongs to the white list. In this case, the image processing apparatus may determine that the at least one attribute does not meet at least one attribute filtering condition.

In this implementation mode, the image processing apparatus determines whether the attribute of the event to be monitored meets the attribute filtering condition according to the size of the monitored object and the size range, which may improve the accuracy of the target monitoring result.

As an optional implementation mode, the at least one image to be processed includes a third image and a fourth image, and a time stamp of the third image is earlier than a time stamp of the fourth image. The at least one attribute filtering condition includes a duration threshold, and the at least one attribute includes a duration of the event to be monitored. The image processing apparatus performs the following operation during the operation in 103.

In 6, the time stamp of the third image is taken as the start time of the event to be monitored, and the time stamp of the fourth image is taken as the end time of the event to be monitored, to obtain the duration.

For example, assuming that the event to be monitored is illegal parking, the image processing apparatus determines that the vehicle A in the third image is in the illegal parking area by performing event detection on the third image, and determines that the vehicle A in the fourth image is in the illegal parking area by performing event detection on the fourth image. The image processing apparatus then determines that the duration of illegal parking of the vehicle A is from the time of acquiring the third image to the time of acquiring the fourth image. That is, the time stamp of the third image is the start time of illegal parking of the vehicle A, and the time stamp of the fourth image is the end time of illegal parking of the vehicle A.

It is to be understood that the third image and the fourth image in the embodiments of the disclosure are only examples, and in an actual processing, the image processing apparatus may obtain the duration of the event to be monitored according to at least two images to be processed.

In this implementation mode, the image processing apparatus determines whether the duration of the event to be monitored exceeds the duration threshold by comparing the duration of the event to be monitored with the duration threshold, so as to determine whether the at least one attribute meets at least one attribute filtering condition.

Specifically, when the image processing apparatus determines that the duration exceeds the duration threshold, it is indicated that the at least one attribute meets at least one attribute filtering condition. When the image processing apparatus determines that the duration does not exceed the duration threshold, it is indicated that the at least one attribute does not meet at least one attribute filtering condition.

Optionally, the image processing apparatus may also perform object detection on the at least one image to be processed to obtain the location of the monitored object in the event to be monitored and take the location as at least one attribute of the event to be monitored.

For example, the event to be monitored is that an electric vehicle illegally enters a residential building. The image processing apparatus obtains the location of the electric vehicle in the third image and the location of the electric vehicle in the fourth image by performing electric vehicle detection on the third image and the fourth image. When both the location of the electric vehicle in the third image and the location of the electric vehicle in the fourth image are in an area of the residential building, and the duration of the electric vehicle in the residential building exceeds the duration threshold, the image processing apparatus determines that the at least one attribute meets at least one attribute filtering condition. In other cases, the image processing apparatus considers that the at least one attribute does not meet at least one attribute filtering condition.

For another example, the event to be monitored is not wearing a safety helmet on a site. The image processing apparatus obtains the location of a person in the third image and the location of the person in the fourth image by performing electric vehicle detection on the third image and the fourth image. When both the location of the person in the third image and the location of the person in the fourth image are in an area of the site, and the duration of the person on the site exceeds the duration threshold, the image processing apparatus determines that the at least one attribute meets at least one attribute filtering condition. In other cases, the image processing apparatus considers that the at least one attribute does not meet at least one attribute filtering condition.

For another example, the event to be monitored is making a call at a gas station. The image processing apparatus obtains the location of a person in the third image and the location of the person in the fourth image by performing electric vehicle detection on the third image and the fourth image. When both the location of the person in the third image and the location of the person in the fourth image are in an area of the gas station, and the duration of the person in the gas station exceeds the duration threshold, the image processing apparatus determines that the at least one attribute meets at least one attribute filtering condition. In other cases, the image processing apparatus considers that the at least one attribute does not meet at least one attribute filtering condition.

As an optional implementation mode, the event to be monitored includes illegal parking, the at least one attribute filtering condition also includes an illegal parking area, the at least one attribute includes the location of the monitored vehicle, and both the third image and the fourth image include the monitored vehicle. The image processing apparatus also performs the following operation during the operation in 103.

In 7, vehicle detection is performed on the third image to obtain a first location of the monitored vehicle in the third image.

In the embodiments of the disclosure, the location of the monitored vehicle in the image may be the location of the vehicle box including the monitored vehicle in a pixel coordinate system of the image. For example, the location of the monitored vehicle in the image may be the coordinate of the diagonal coordinate of the vehicle box including the monitored vehicle in the pixel coordinate system.

The image processing apparatus may obtain the location of the monitored vehicle in the third image, namely the first location, by performing vehicle detection on the third image.

In 8, vehicle detection is performed on the fourth image to obtain a second location of the monitored vehicle in the fourth image.

The image processing apparatus may obtain the location of the monitored vehicle in the fourth image, namely the second location, by performing vehicle detection on the fourth image.

In this implementation mode, the image processing apparatus determines whether the duration of the event to be monitored exceeds the duration threshold by comparing the duration of the event to be monitored with the duration threshold, and determines whether the location of the monitored vehicle is in the illegal parking area, so as to determine whether the at least one attribute meets at least one attribute filtering condition.

Specifically, when the image processing apparatus determines that the duration exceeds the duration threshold and both the first location and the second location are in the illegal parking area, it is indicated that the at least one attribute meets at least one attribute filtering condition.

The image processing apparatus determines that the at least one attribute does not meet at least one attribute filtering condition when determining that at least one of the following cases occurs: the duration does not exceed the duration threshold, the first location is outside the illegal parking area, or the second location is outside the illegal parking area.

Specifically, if the image processing apparatus determines that the duration does not exceed the duration threshold and both the first location and the second location are in the illegal parking area, it is indicated that the at least one attribute does not meet at least one attribute filtering condition.

If the image processing apparatus determines that the duration does not exceed the duration threshold, the first location is outside the illegal parking area, and the second location is in the illegal parking area, it is indicated that the at least one attribute does not meet at least one attribute filtering condition.

If the image processing apparatus determines that the duration does not exceed the duration threshold, the first location is in the illegal parking area, and the second location is outside the illegal parking area, it is indicated that the at least one attribute does not meet at least one attribute filtering condition.

If the image processing apparatus determines that the duration exceeds the duration threshold and both the first location and the second location are outside the illegal parking area, it is indicated that the at least one attribute does not meet at least one attribute filtering condition.

If the image processing apparatus determines that the duration does not exceed the duration threshold and both the first location and the second location are outside the illegal parking area, it is indicated that the at least one attribute does not meet at least one attribute filtering condition.

As an optional implementation mode, the at least one image to be processed includes a fifth image, and the at least one attribute filtering condition includes a confidence threshold. The image processing apparatus also performs the following operation during the operation in 103.

In 9, object detection is performed on the fifth image to obtain the confidence of the monitored object in the fifth image.

In this operation, the monitored object may be a person or an object. The confidence of the monitored object represents the credibility of the monitored object. For example, when the monitored object is a person, the confidence of the monitored object represents the probability that the monitored object in the fifth image is a person, and when the monitored object is a vehicle, the confidence of the monitored object represents the probability that the monitored object in the fifth image is a vehicle.

In this implementation mode, the image processing apparatus determines whether the monitored object in the image is credible by comparing the confidence of the monitored object with the confidence threshold, so as to determine whether the at least one attribute meets at least one attribute filtering condition.

Specifically, if the image processing apparatus determines that the confidence of the monitored object exceeds the confidence threshold, it is indicated that the at least one attribute meets at least one attribute filtering condition. If the image processing apparatus determines that the confidence of the monitored object does not exceed the confidence threshold, it is indicated that the at least one attribute does not meet at least one attribute filtering condition.

As an optional implementation mode, the at least one image to be processed includes a sixth image, and the at least one attribute filtering condition includes an alarm period. The image processing apparatus also performs the following operation during the operation in 103.

In 10, a time stamp of the sixth image is taken as the occurrence time of the event to be monitored.

In the embodiments of the disclosure, the sixth image is an image with the latest time stamp among the at least one image to be processed. The alarm period is a period during which the image processing apparatus alarms when determining the occurrence of the event to be monitored. For example, if the event to be monitored is garbage overflow, the image processing apparatus outputs alarm information to remind the staff to clean the garbage in time when determining that the garbage overflowing event has occurred. However, the period of time from 23:00 to 4:00 is the off-duty time of the staff every day, and it is obviously unreasonable to output the alarm information during this period, so this period may be taken as the alarm period.

In this implementation mode, the image processing apparatus determines whether the occurrence time of the event to be monitored is in the alarm period to determine whether the at least one attribute meets at least one attribute filtering condition.

Specifically, if the image processing apparatus determines that the occurrence time of the event to be monitored is outside the alarm period, it is indicated that the at least one attribute meets at least one attribute filtering condition. If the image processing apparatus determines that the occurrence time of the event to be monitored is in the alarm period, it is indicated that the at least one attribute does not meet at least one attribute filtering condition.

As an optional implementation mode, when the number of the attribute filtering condition is more than 1, before performing the operation in 103, the image processing apparatus also performs the following operation.

In 11, a priority order of attributes of the event to be monitored corresponding to the filtering conditions is obtained.

In the embodiments of the disclosure, the higher the priority of the attribute of the event to be monitored is, the less the amount of data processing is required to extract the attribute from the image to be processed. For example, the amount of data processing required by the image processing apparatus to obtain the time stamp of image from the image is less than the amount of data processing required to extract the location of vehicle from the image. Therefore, for the event to be monitored, the priority of the duration is higher than that of the location of vehicle.

In an implementation mode of obtaining the priority order of the attributes of the event to be monitored, the image processing apparatus receives a priority order input by a user through an input component as the priority order of the attributes of the event to be monitored. The input component includes a keyboard, a mouse, a touch screen, a touch pad, an audio input unit, etc.

In another implementation mode of obtaining the priority order of the attributes of the event to be monitored, the image processing apparatus receives a priority order sent by a second terminal as the priority order of the attributes of the event to be monitored. Optionally, the second terminal may be any one of a mobile phone, a computer, a tablet computer, a server, or a wearable device. The second terminal and the first terminal may be the same or different.

After performing the operation in 11, the image processing apparatus performs the following operations during the operation in 103.

In 12, first attribute extraction is performed on the at least one image to be processed to obtain a first attribute of the event to be monitored.

In the embodiments of the disclosure, the first attribute is the attribute with the highest priority in the priority order. For example (example 1), the event to be monitored is illegal parking. The attributes of the event to be monitored include a duration, a vehicle location, and a vehicle size. It is assumed that in the priority order of the attributes of the event to be monitored, the attribute with the highest priority is the duration, the attribute with the second highest priority is the vehicle size, and the attribute with the lowest priority is the vehicle location.

In this operation, the image processing apparatus first performs first attribute extraction on the at least one image to be processed to obtain the first attribute of the event to be monitored. For example, in Example 1, the image processing apparatus first obtains the time stamp of at least one image to be processed.

In 13, when the first attribute meets the attribute filtering condition corresponding to the first attribute, second attribute extraction is performed on the at least one image to be processed to obtain a second attribute of the event to be monitored.

In the embodiments of the disclosure, the second attribute is the attribute with the second highest priority in the priority order. For example, in Example 1, the second attribute is the vehicle size.

After obtaining the first attribute, the image processing apparatus determines whether the first attribute meets the attribute filtering condition corresponding to the first attribute in the at least one attribute filtering condition. When the first attribute meets the attribute filtering condition corresponding to the first attribute, the image processing apparatus performs the second attribute extraction on the at least one image to be processed to obtain the second attribute of the event to be monitored.

Taking Example 1 for example, when determining that the duration of a vehicle stop exceeds the duration threshold, the image processing apparatus performs vehicle detection on the at least one image to be processed to obtain the location of the vehicle in the image to be processed.

In 14, when the first attribute does not meet the filtering condition corresponding to the first attribute, event attribute extraction on the at least one image to be processed is stopped.

If the first attribute does not meet the attribute filtering condition corresponding to the first attribute, it is indicated that at least one attribute to be monitored does not meet at least one attribute filtering condition. Therefore, the image processing apparatus does not need to extract attributes, except the first attribute, from the at least one image to be processed, thereby reducing the amount of data processing.

Optionally, if the second attribute meets the attribute filtering condition corresponding to the second attribute, third attribute extraction is performed on the at least one image to be processed to obtain a third attribute of the event to be monitored. Then, the image processing apparatus determines whether the third attribute meets the attribute filtering condition corresponding to the third attribute, and repeats the operation until a certain attribute does not meet the attribute filtering condition corresponding to the attribute, and the image processing apparatus stops performing attribute extraction. Alternatively, the image processing apparatus determines whether the third attribute meets the attribute filtering condition corresponding to the third attribute, and repeats the operation until all attributes of the event to be monitored are extracted.

In the embodiments of the disclosure, when the attribute with a high priority meets the attribute filtering condition, the image processing apparatus extracts the attribute with the second highest priority from the at least one image to be processed, which may reduce the amount of data processing and improve a processing speed.

As an optional implementation mode, the image processing apparatus outputs alarm information when determining that the target monitoring result is that the event to be monitored does not occur. The alarm information includes at least one of the following: text, sound, light, vibration, smell, instruction, or low current stimulation. For example, the image processing apparatus may send an alarm instruction to the terminal. The alarm instruction is used for instructing the terminal to output the alarm information.

Based on the technical solutions provided by the embodiments of the disclosure, the embodiments of the disclosure also provide several possible application scenarios.

In the first scenario, the crime of gathering crowds to disturb social order refers to an act of gathering crowds to disturb social order so seriously that work, production, business, teaching, scientific research and medical treatment cannot be carried out to cause serious losses. With the increase of surveillance cameras, a related electronic device may determine whether there is a people gathering event through processing the video stream acquired by the surveillance camera, thus reducing the occurrence of public security accidents.

For example, there is a server at the law enforcement center of place A, and there is a communication connection between the server and the surveillance camera in the place A. The server may obtain the video stream acquired by the surveillance camera through the communication connection. The server may obtain the intermediate detection result by processing one or more images in the video stream through the computer vision model. The server may obtain the number of people in an image by performing attribute extraction on the image in the video stream.

Assuming that the attribute filtering condition of the event to be monitored is at least 5 people, that is, the case that the number of people does not exceed 5 is not regarded as the people gathering event. Then based on the above technical solutions, the server may obtain the target monitoring result according to the number of people in the image and the intermediate detection result.

When the target monitoring result is that there is a people gathering event, the server may send an alarm instruction to the terminal of the relevant management personnel to remind the relevant management personnel of occurrence of the people gathering event. Optionally, the alarm instruction carries the occurrence location and time of the people gathering event.

In the second scenario, only the vehicle belonging to a vehicle white list is allowed to park in a certain parking lot, and the entry of the vehicle not belonging to the vehicle white list belongs to illegal intrusion. The surveillance camera is installed at the entrance of the parking lot, and the video stream acquired by the surveillance camera is sent to a server. The server determines whether there is a vehicle entering the parking lot by processing the video stream through the computer vision model, and obtains the intermediate detection result. The server performs attribute extraction on the video stream to obtain the license plate number of the vehicle entering the parking lot.

Assuming that the vehicle white list includes at least one license plate number, when the intermediate detection result is that there is a vehicle entering the parking lot and there is no vehicle number matching with the license plate number of the vehicle in the vehicle white list, the server determines that the vehicle intrudes illegally. Then, the server may send an alarm instruction to the terminal of the relevant management personnel to remind the relevant management personnel that a vehicle has illegally intruded the parking lot. Optionally, the alarm instruction carries the license plate number of the vehicle intruding illegally.

It is to be understood by those skilled in the art that, in the methods of the specific implementation modes, the writing sequence of each operation does not mean a strict execution sequence and is not intended to form any limit to the implementation process, and a specific execution sequence of each operation should be determined by its function and an internal logic.

The method of the embodiments of the disclosure is described in detail above, and an apparatus of the embodiments of the disclosure is provided below.

Referring to FIG. 2, FIG. 2 is a structural schematic diagram of an image processing apparatus provided by an embodiment of the disclosure. The image processing apparatus 1 may include an obtaining unit 11, an event detecting unit 12, an attribute extracting unit 13, and a processing unit 14.

The obtaining unit 11 is configured to obtain at least one image to be processed and at least one attribute filtering condition of the event to be monitored.

The event detecting unit 12 is configured to perform event detection on the at least one image to be processed to obtain an intermediate detection result of the event to be monitored.

The attribute extracting unit 13 is configured to perform event attribute extraction on the at least one image to be processed to obtain at least one attribute of the event to be monitored.

The processing unit 14 is configured to obtain a target monitoring result of the event to be monitored according to the intermediate detection result, the at least one attribute and the at least one attribute filtering condition of the event to be monitored.

In combination with any implementation mode of the disclosure, the processing unit 14 is configured to:

when the intermediate detection result is that the event to be monitored exists in the at least one image to be processed, and the at least one attribute meets the at least one attribute filtering condition, determine the target monitoring result to be that the event to be monitored has occurred; and

when the intermediate detection result is that the event to be monitored exists in the at least one image to be processed, and the at least one attribute does not meet the at least one attribute filtering condition, determine the target monitoring result to be that the event to be monitored does not occur.

In combination with any implementation mode of the disclosure, the attribute extracting unit 13 is configured to:

when the intermediate detection result is that the event to be monitored exists in the at least one image to be processed, perform event attribute extraction on the at least one image to be processed to obtain at least one attribute of the event to be monitored.

In combination with any implementation mode of the disclosure, the event to be monitored includes illegal intrusion, the at least one image to be processed includes the first image, and the first image includes an illegal intrusion area.

The event detecting unit 12 is configured to:

when it is determined that there is a monitored object in the illegal intrusion area, determine the intermediate detection result to be that the illegal intrusion exists in the first image, the monitored objects including at least one of a person or a non-motor vehicle; and

when it is determined that there is no monitored object in the illegal intrusion area, determine the intermediate detection result to be that the illegal intrusion does not exist in the first image.

In combination with any implementation mode of the disclosure, the at least one image to be processed includes a second image, the at least one attribute filtering condition includes a white list feature database, and the at least one attribute includes identity features of the monitored object.

The attribute extracting unit 13 is configured to perform identity feature extraction on the second image to obtain the identity feature data of the monitored object.

The condition that the at least one attribute meets the at least one attribute filtering condition includes: there is no feature data matching with the identity feature data in the white list feature database.

The condition that the at least one attribute does not meet the at least one attribute filtering condition includes: there is feature data matching with the identity feature data in the white list feature database.

In combination with any implementation mode of the disclosure, the at least one attribute filtering condition also includes a size range, and the at least one attribute also includes a size of the monitored object.

The attribute extracting unit 13 is configured to perform object detection on the second image to obtain the size of the monitored object.

The condition that the at least one attribute meets the at least one attribute filtering condition includes: there is no feature data matching with the identity feature data in the white list feature database, and the size of the monitored object is in the size range.

The condition that the at least one attribute does not meet the at least one attribute filtering condition includes: there is feature data matching with the identity feature data in the white list feature database, and/or the size of the monitored object is outside the size range.

In combination with any implementation mode of the disclosure, the at least one image to be processed includes a third image and a fourth image, and the time stamp of the third image is earlier than the time stamp of the fourth image. The at least one attribute filtering condition includes a duration threshold, and the at least one attribute includes the duration of the event to be monitored.

The attribute extracting unit 13 is configured to take the time stamp of the third image as a start time of the event to be monitored, and take the time stamp of the fourth image as an end time of the event to be monitored, to obtain the duration.

The condition that the at least one attribute meets the at least one attribute filtering condition includes: the duration exceeds the duration threshold.

The condition that the at least one attribute does not meet the at least one attribute filtering condition includes: the duration does not exceed the duration threshold.

In combination with any implementation mode of the disclosure, the event to be monitored includes illegal parking, the at least one attribute filtering condition also includes an illegal parking area, the at least one attribute includes a location of the monitored vehicle, and both the third image and the fourth image include the monitored vehicle.

The attribute extracting unit 13 is configured to perform vehicle detection on the third image to obtain a first location of the monitored vehicle in the third image, and perform vehicle detection on the fourth image to obtain a second location of the monitored vehicle in the fourth image.

The condition that the at least one attribute meets the at least one attribute filtering condition includes: the duration exceeds the duration threshold, and both the first location and the second location are within the illegal parking area.

The condition that the at least one attribute does not meet the at least one attribute filtering condition includes at least one of the following: the duration does not exceed the duration threshold, the first location is outside the illegal parking area, or the second location is outside the illegal parking area.

In combination with any implementation mode of the disclosure, the at least one image to be processed includes a fifth image, and the at least one attribute filtering condition includes a confidence threshold.

The attribute extracting unit 13 is configured to perform object detection on the fifth image to obtain the confidence of the monitored object in the fifth image.

The condition that the at least one attribute meets the at least one attribute filtering condition includes: the confidence of the monitored object exceeds the confidence threshold.

The condition that the at least one attribute does not meet the at least one attribute filtering condition includes: the confidence of the monitored object does not exceed the confidence threshold.

In combination with any implementation mode of the disclosure, the at least one attribute filtering condition includes an alarm period.

The attribute extracting unit 13 is configured to take a time stamp of a sixth image as the occurrence time of the event to be monitored. The sixth image is an image with the latest time stamp among the at least one image to be processed.

The condition that the at least one attribute meets the at least one attribute filtering condition includes: the occurrence time of the event to be monitored is outside the alarm period.

The condition that the at least one attribute does not meet the at least one attribute filtering condition includes: the occurrence time of the event to be monitored is within the alarm period.

In combination with any implementation mode of the disclosure, the obtaining unit 11 is further configured to, when the number of attribute filtering conditions exceeds 1, before event attribute extraction is performed on the at least one image to be processed to obtain at least one attribute of the event to be monitored, obtain a priority order of attributes of the event to be monitored corresponding to the filtering conditions.

The attribute extracting unit 13 is configured to:

perform first attribute extraction on the at least one image to be processed to obtain a first attribute of the event to be monitored, the first attribute being the attribute with the highest priority in the priority order;

when the first attribute meets the attribute filtering condition corresponding to the first attribute, perform second attribute extraction on the at least one image to be processed to obtain a second attribute of the event to be monitored, the second attribute being the attribute with the second highest priority in the priority order; and

when the first attribute does not meet the filtering condition corresponding to the first attribute, stop performing event attribute extraction on the at least one image to be processed.

In combination with any implementation mode of the disclosure, the image processing apparatus 1 may further include an outputting unit 15.

The outputting unit 15 is configured to output alarm information when the target monitoring result is that the event to be monitored does not occur.

In the embodiments of the disclosure, by filtering the intermediate detection result according to the attribute and attribute filtering condition of the event to be monitored, the image processing apparatus may filter out the detection result that the attribute does not meet the attribute filtering condition, and obtain the target monitoring result, thereby improving the accuracy of the target monitoring result.

In some embodiments, the device provided in the embodiments of the disclosure may have functions or modules configured to perform the method described in the above method embodiments, the specific implementation of which may refer to the description of the above method embodiments, and will not be elaborated here for simplicity.

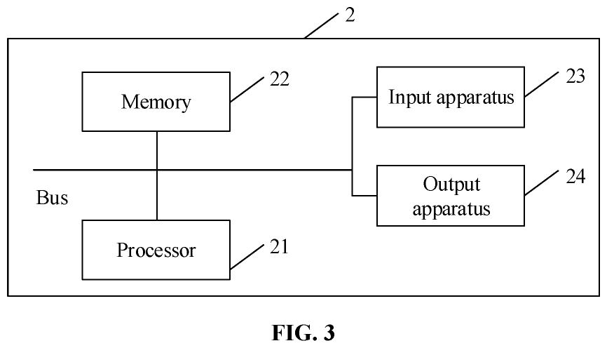

FIG. 3 is a hardware structure diagram of an image processing apparatus provided by an embodiment of the disclosure. The image processing apparatus 2 includes a processor 21, a memory 22, an input apparatus 23, and an output apparatus 24. The processor 21, the memory 22, the input apparatus 23, and the output apparatus 24 are coupled through a connector. The connector includes various interfaces, transmission lines, or buses, etc. No limits are made thereto in the embodiments of the disclosure. It is to be understood that, in each embodiment of the disclosure, coupling refers to interconnection implemented in a specific manner, including direct connection or direct connection through another device, for example, connection through various interfaces, transmission lines and buses.

The processor 21 may be one or more Graphics Processing Units (GPUs). In the case that the processor 21 is a GPU, the GPU may be a single-core GPU, or may be a multi-core GPU. Optionally, the processor 21 may be a processor set consisting of multiple GPUs, and multiple processors are coupled with one another through one or more buses. Optionally, the processor may also be a processor of another type, etc. No limits are made in the embodiment of the disclosure.

The memory 22 may be configured to store a computer program instruction and various computer program codes including a program code configured to execute the solutions of the disclosure. Optionally, the memory 22 includes, but is not limited to, a Random Access memory (RAM), a Read-Only Memory (ROM), an Erasable Programmable Read-only Memory (EPROM), or a Compact Disc Read-Only Memory (CD-ROM). The memory 22 is configured to store related instructions and data.

The input apparatus 23 is configured to input data and/or signals, and the output apparatus 24 is configured to output data and/or signals. The input apparatus 23 and the output apparatus 24 may be independent devices, or may be integrated.

It can be understood that, in the embodiments of the disclosure, the memory 22 may not only be configured to store related instructions but also be configured to store related data. For example, the memory 22 may be configured to store at least one image to be processed and at least one attribute filtering condition obtained by the input apparatus 23, or the memory 22 may also be configured to store the target monitoring result obtained by the processor 21, etc. Data specifically stored in the memory 22 is not limited in the embodiment of the disclosure.

It is to be understood that FIG. 3 shows only a simplified design of an image processing apparatus. In practical applications, the image processing apparatus may also include other necessary components, which are, but not limited to, any number of input/output apparatus, processors, memories, etc., and all image processing apparatus that can implement the embodiments of the disclosure are within the protection scope of the disclosure.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiments and will not be elaborated herein for convenient and brief description. Those skilled in the art may also clearly know that the embodiments of the disclosure are described with different focuses. For ease and briefness of description, elaborations about the same or similar parts may be omitted in different embodiments, and thus parts that are not described or detailed in an embodiment may refer to records in the other embodiments.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

The embodiments may be implemented completely or partially through software, hardware, firmware or any combination thereof. During implementation with the software, the embodiments may be implemented completely or partially in form of a computer program product. The computer program product includes one or more computer instructions. When the computer program instruction is loaded and executed on a computer, the flows or functions according to the embodiments of the disclosure are completely or partially generated. The computer may be a universal computer, a dedicated computer, a computer network, or another programmable device. The computer instruction may be stored in a computer-readable storage medium or transmitted through the computer-readable storage medium. The computer instruction may be transmitted from one website, computer, server or data center to another website, computer, server or data center in a wired (for example, a coaxial cable, an optical fiber and a Digital Subscriber Line (DSL)) or wireless (for example, infrared, radio and microwave) manner. The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program, the program may be stored in a computer-readable storage medium, and when the program is executed, the flows of each method embodiment may be included. The storage medium includes various media capable of storing program codes, such as a ROM, a RAM, a magnetic disk, or an optical disk.

### INDUSTRIAL APPLICABILITY

The embodiments of the disclosure disclose an image processing method and apparatus, an electronic device and a storage medium. The image processing method includes that: at least one image to be processed and at least one attribute filtering condition of an event to be monitored are obtained; event detection is performed on the at least one image to be processed to obtain an intermediate detection result of the event to be monitored; event attribute extraction is performed on the at least one image to be processed to obtain at least one attribute of the event to be monitored; and a target monitoring result of the event to be monitored is obtained according to the intermediate detection result, at least one attribute and at least one attribute filtering condition of the event to be monitored. The above solution corrects a determination result of the computer vision model for the violations, thereby improving the accuracy of determining the violations.

1. An image processing method, comprising:
obtaining at least one image to be processed and at least one attribute filtering condition of an event to be monitored;
performing event detection on the at least one image to be processed to obtain an intermediate detection result of the event to be monitored;
performing event attribute extraction on the at least one image to be processed to obtain at least one attribute of the event to be monitored; and
obtaining a target monitoring result of the event to be monitored according to the intermediate detection result, the at least one attribute and the at least one attribute filtering condition of the event to be monitored.

2. The method of claim 1, wherein obtaining the target monitoring result of the event to be monitored according to the intermediate detection result, the at least one attribute and the at least one attribute filtering condition of the event to be monitored comprises:
when the intermediate detection result is that the event to be monitored exists in the at least one image to be processed, and the at least one attribute meets the at least one attribute filtering condition, determining the target monitoring result to be that the event to be monitored has occurred; and
when the intermediate detection result is that the event to be monitored exists in the at least one image to be processed, and the at least one attribute does not meet the at least one attribute filtering condition, determining the target monitoring result to be that the event to be monitored does not occur.

3. The method of claim 1, wherein performing event attribute extraction on the at least one image to be processed to obtain the at least one attribute of the event to be monitored comprises:
when the intermediate detection result is that the event to be monitored exists in the at least one image to be processed, performing event attribute extraction on the at least one image to be processed to obtain the at least one attribute of the event to be monitored.

4. The method of claim 3, wherein the event to be monitored comprises illegal intrusion, the at least one image to be processed comprises a first image, and the first image comprises an illegal intrusion area;
performing event detection on the at least one image to be processed to obtain the intermediate detection result comprises:
when it is determined that there is a monitored object in the illegal intrusion area, determining the intermediate detection result to be that the illegal intrusion exists in the first image, the monitored object comprising at least one of a person or a non-motor vehicle; and
when it is determined that there is no monitored object in the illegal intrusion area, determining the intermediate detection result to be that the illegal intrusion does not exist in the first image.

5. The method of claim 1, wherein the at least one image to be processed comprises a second image, the at least one attribute filtering condition comprises a white list feature database, and the at least one attribute comprises an identity feature of a monitored object;
performing event attribute extraction on the at least one image to be processed to obtain the at least one attribute of the event to be monitored comprises:
performing identity feature extraction on the second image to obtain identity feature data of the monitored object;
wherein the condition that the at least one attribute meets the at least one attribute filtering condition comprises: there is no feature data matching with the identity feature data in the white list feature database;
the condition that the at least one attribute does not meet the at least one attribute filtering condition comprises: there is feature data matching with the identity feature data in the white list feature database.

6. The method of claim 5, wherein the at least one attribute filtering condition further comprises a size range, and the at least one attribute further comprises a size of the monitored object;
performing event attribute extraction on the at least one image to be processed to obtain the at least one attribute of the event to be monitored further comprises:
performing object detection on the second image to obtain the size of the monitored object;
wherein the condition that the at least one attribute meets the at least one attribute filtering condition comprises: there is no feature data matching with the identity feature data in the white list feature database and the size of the monitored object is in the size range;
the condition that the at least one attribute does not meet the at least one attribute filtering condition comprises: there is feature data matching with the identity feature data in the white list feature database, and/or the size of the monitored object is outside the size range.

7. The method of claim 1, wherein the at least one image to be processed comprises a third image and a fourth image, and a time stamp of the third image is earlier than a time stamp of the fourth image, the at least one attribute filtering condition comprises a duration threshold, and the at least one attribute comprises a duration of the event to be monitored;
performing event attribute extraction on the at least one image to be processed to obtain the at least one attribute of the event to be monitored comprises:
taking the time stamp of the third image as a start time of the event to be monitored, and taking the time stamp of the fourth image as an end time of the event to be monitored, to obtain the duration;
wherein the condition that the at least one attribute meets the at least one attribute filtering condition comprises: the duration exceeds the duration threshold;
the condition that the at least one attribute does not meet the at least one attribute filtering condition comprises: the duration does not exceed the duration threshold.

8. The method of claim 7, wherein the event to be monitored comprises illegal parking, the at least one attribute filtering condition further comprises an illegal parking area, the at least one attribute comprises a location of a monitored vehicle, and both the third image and the fourth image comprise the monitored vehicle;
performing event attribute extraction on the at least one image to be processed to obtain the at least one attribute of the event to be monitored comprises:
performing vehicle detection on the third image to obtain a first location of the monitored vehicle in the third image; and
performing vehicle detection on the fourth image to obtain a second location of the monitored vehicle in the fourth image;
wherein the condition that the at least one attribute meets the at least one attribute filtering condition comprises: the duration exceeds the duration threshold, and both the first location and the second location are within the illegal parking area;
the condition that the at least one attribute does not meet the at least one attribute filtering condition comprises at least one of the following: the duration does not exceed the duration threshold, the first location is outside the illegal parking area, or the second location is outside the illegal parking area.

9. The method of claim 1, wherein the at least one image to be processed comprises a fifth image, and the at least one attribute filtering condition comprises a confidence threshold;
performing event attribute extraction on the at least one image to be processed to obtain the at least one attribute of the event to be monitored comprises:
performing object detection on the fifth image to obtain a confidence of a monitored object in the fifth image;
wherein the condition that the at least one attribute meets the at least one attribute filtering condition comprises: the confidence of the monitored object exceeds the confidence threshold;
the condition that the at least one attribute does not meet the at least one attribute filtering condition comprises: the confidence of the monitored object does not exceed the confidence threshold.

10. The method of claim 1, wherein the at least one attribute filtering condition comprises an alarm period;
performing event attribute extraction on the at least one image to be processed to obtain the at least one attribute of the event to be monitored comprises:
taking a time stamp of a sixth image as an occurrence time of the event to be monitored, the sixth image being an image with the latest time stamp among the at least one image to be processed;
wherein the condition that the at least one attribute meets the at least one attribute filtering condition comprises: the occurrence time of the event to be monitored is outside the alarm period;
the condition that the at least one attribute does not meet the at least one attribute filtering condition comprises: the occurrence time of the event to be monitored is within the alarm period.

11. The method of claim 1, wherein when a number of attribute filtering conditions is more than 1, the method further comprises: before performing event attribute extraction on the at least one image to be processed to obtain the at least one attribute of the event to be monitored,
obtaining a priority order of attributes of the event to be monitored corresponding to the filtering conditions;
performing event attribute extraction on the at least one image to be processed to obtain the at least one attribute of the event to be monitored comprises:
performing first attribute extraction on the at least one image to be processed to obtain a first attribute of the event to be monitored, the first attribute being an attribute with the highest priority in the priority order;
when the first attribute meets the attribute filtering condition corresponding to the first attribute, performing second attribute extraction on the at least one image to be processed to obtain a second attribute of the event to be monitored, the second attribute being an attribute with the second highest priority in the priority order; and
when the first attribute does not meet the filtering condition corresponding to the first attribute, stopping performing event attribute extraction on the at least one image to be processed.

12. The method of claim 1, further comprising:
when the target monitoring result is that the event to be monitored does not occur, outputting alarm information.

13. An electronic device, comprising: a processor and a non-transitory computer-readable storage medium for storing instructions executable by the processor;
wherein the processor is configured to:
obtain at least one image to be processed and at least one attribute filtering condition of an event to be monitored;
perform event detection on the at least one image to be processed to obtain an intermediate detection result of the event to be monitored;
perform event attribute extraction on the at least one image to be processed to obtain at least one attribute of the event to be monitored; and
obtain a target monitoring result of the event to be monitored according to the intermediate detection result, the at least one attribute and the at least one attribute filtering condition of the event to be monitored.

14. The electronic device of claim 13, wherein the processor is further configured to:
when the intermediate detection result is that the event to be monitored exists in the at least one image to be processed, and the at least one attribute meets the at least one attribute filtering condition, determine the target monitoring result to be that the event to be monitored has occurred; and
when the intermediate detection result is that the event to be monitored exists in the at least one image to be processed, and the at least one attribute does not meet the at least one attribute filtering condition, determine the target monitoring result to be that the event to be monitored does not occur.

15. The electronic device of claim 13, wherein the processor is further configured to:
when the intermediate detection result is that the event to be monitored exists in the at least one image to be processed, perform event attribute extraction on the at least one image to be processed to obtain the at least one attribute of the event to be monitored.

16. The electronic device of claim 13, wherein the at least one image to be processed comprises a second image, the at least one attribute filtering condition comprises a white list feature database, and the at least one attribute comprises an identity feature of a monitored object;
wherein the processor is further configured to:
perform identity feature extraction on the second image to obtain identity feature data of the monitored object;
wherein the condition that the at least one attribute meets the at least one attribute filtering condition comprises: there is no feature data matching with the identity feature data in the white list feature database;
the condition that the at least one attribute does not meet the at least one attribute filtering condition comprises: there is feature data matching with the identity feature data in the white list feature database.

17. The electronic device of claim 13, wherein the at least one image to be processed comprises a third image and a fourth image, and a time stamp of the third image is earlier than a time stamp of the fourth image, the at least one attribute filtering condition comprises a duration threshold, and the at least one attribute comprises a duration of the event to be monitored;
wherein the processor is further configured to:
take the time stamp of the third image as a start time of the event to be monitored, and take the time stamp of the fourth image as an end time of the event to be monitored, to obtain the duration;
wherein the condition that the at least one attribute meets the at least one attribute filtering condition comprises: the duration exceeds the duration threshold;
the condition that the at least one attribute does not meet the at least one attribute filtering condition comprises: the duration does not exceed the duration threshold.

18. The electronic device of claim 13, wherein the at least one image to be processed comprises a fifth image, and the at least one attribute filtering condition comprises a confidence threshold;
wherein the processor is further configured to:
perform object detection on the fifth image to obtain a confidence of a monitored object in the fifth image;
wherein the condition that the at least one attribute meets the at least one attribute filtering condition comprises: the confidence of the monitored object exceeds the confidence threshold;
the condition that the at least one attribute does not meet the at least one attribute filtering condition comprises: the confidence of the monitored object does not exceed the confidence threshold.

19. The electronic device of claim 13, wherein the at least one attribute filtering condition comprises an alarm period;
wherein the processor is further configured to:
take a time stamp of a sixth image as an occurrence time of the event to be monitored, the sixth image being an image with the latest time stamp among the at least one image to be processed;
wherein the condition that the at least one attribute meets the at least one attribute filtering condition comprises: the occurrence time of the event to be monitored is outside the alarm period;
the condition that the at least one attribute does not meet the at least one attribute filtering condition comprises: the occurrence time of the event to be monitored is within the alarm period.

20. A non-transitory computer readable storage medium, having stored a computer program thereon, wherein the computer program comprises a program instruction that when executed by a processor, enables the processor to execute an image processing method, comprising:
obtaining at least one image to be processed and at least one attribute filtering condition of an event to be monitored;
performing event detection on the at least one image to be processed to obtain an intermediate detection result of the event to be monitored;
performing event attribute extraction on the at least one image to be processed to obtain at least one attribute of the event to be monitored; and
obtaining a target monitoring result of the event to be monitored according to the intermediate detection result, the at least one attribute and the at least one attribute filtering condition of the event to be monitored.
